(19) United States
(12) Patent Application Publication
(10) Pub. No.: US 2010/0269136 A1
(43) Pub. Date: Oct. 21, 2010

(54) TELEVISION OPERATION INTERFACE DISPLAY SYSTEM AND OPERATION METHOD FOR SWITCHING TELEVISION CHANNELS

(75) Inventor: KUAN-HUA HUANG, Zhonghe City (TW)

Correspondence Address: Wang Law Firm, Inc., 4989 Peachtree Parkway,, Suite 200, Norcross, GA, 30092, US

(73) Assignee: MITAC INTERNATIONAL CORP., Taoyuan (TW)

(21) Appl. No.: 12/629,023

(22) Filed: Dec. 1, 2009

(30) Foreign Application Priority Data
Apr. 16, 2009 (TW) 098112710

(51) Int. Cl. H04N 5/445; G06F 3/041

(52) U.S. Cl. 725/38; 345/173

(57) ABSTRACT

A television (TV) operation interface display system and an operation method for switching TV channels are disclosed. The TV operation interface has a channel selection object that has a display zone corresponding to a plurality of TV channels, a bar as an indicating object for a user to move and accordingly select a TV channel, and a channel marker. The bar can automatically align with the channel marker for the user to conveniently switch to a preset favorite channel. The user can touch the bar at a fixed position in the display zone to set a favorite channel. The display zone is divided by the bar into a first zone and a second zone. The user can touch and trigger the first zone or the second zone to switch the TV channels, and can control a switching speed by controlling duration for touching the first or the second zone.

### FIELD OF THE INVENTION

The present invention relates to a television operation interface display system and an operation method for switching television channels; and more particularly, to an operation interface that enables effective selection of all available television channels or favorite channels as well as setting of favorite channels.

### BACKGROUND OF THE INVENTION

With the progress of the mobile communication and wireless network technologies, the currently available portable devices not only provide the functions of wireless communication, wireless access to Internet, and navigation supported by global positioning system (GPS), but also allow users to watch high-quality television (TV) programs under a moving state. However, the portable devices usually have a relatively small display module and are not equipped with a remote controller while there are a large number of channels for digital TVs: Therefore, it is desirable to work out a way for a user to efficiently select desired TV channels and set favorite channels on a small display module.

### SUMMARY OF THE INVENTION

A primary object of the present invention is to provide a television operation interface display system and an operation method for switching television channels to enable high operation efficiency in selecting TV channels.

To achieve the above and other objects, the television operation interface display system according to the present invention for a user to switch TV channels includes a display module, an input module, and a processing module. The processing module controls the display module to show a TV operation interface. The TV operation interface includes a channel selection object that has a display zone corresponding to a plurality of TV channels, an indicating object, such as a bar, and a channel marker. The input module is arranged for accepting the user's input to manipulate the bar. thereby selecting one of the TV channels. When the bar is moved to near the channel marker, the bar automatically aligns with the channel marker and the processing module switches to a TV channel corresponding to the channel marker.

According to another embodiment of the present invention, the television operation interface display system includes a display module, an input module, and a processing module. The processing module controls the display module to show a TV operation interface. The TV operation interface includes a channel selection object that has a display zone corresponding to a plurality of TV channels, and a bar as an indicating object. The input module allows the user to touch and move the bar, so as to control the processing module to switch to a TV channel corresponding to a channel position of the bar. When the bar is touched at a fixed position in the display zone for a time longer than a preset time period, the processing module sets a TV channel corresponding to the fixed position as a favorite channel and shows a channel marker on the fixed position.

To achieve the above and other objects, the operation method for switching TV channels according to the present invention includes the following steps: (1) displaying a TV operation interface; the TV operation interface including a channel selection object, which has a display zone corresponding to a plurality of TV channels; (2) showing in the display zone a bar as an indicating object and a channel marker; (3) moving the bar to select one of the plurality of TV channels; and (4) automatically aligning the bar with the channel marker when the bar is moved to near the channel marker, and switching to a TV channel corresponding to the channel marker.

According to another embodiment of the present invention, the operation method for switching TV channels includes the following steps: (1) displaying a TV operation interface; the TV operation interface including a channel selection object, which has a display zone corresponding to a plurality of TV channels; (2) showing in the display zone a bar as an indicating object; (3) moving the bar to switch to one of the plurality of TV channels at a channel position corresponding to the bar; and (4) setting a TV channel corresponding to a fixed position as a favorite channel and showing a channel marker on the fixed position when the bar is touched at the fixed position in the display zone for a time longer than a preset time period.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exemplary block diagram of a TV operation interface display system according to the present invention;

FIG. 2 is an exemplary view of the TV operation interface of the present invention;

FIG. 3 is another exemplary view of the TV operation interface of the present invention;

FIG. 4 is a flowchart showing the steps included in an operation method for switching TV channels according to the present invention; and

FIG. 5 is a flowchart showing the operation method for switching TV channels according to an embodiment of the present invention.

### DETAILED DESCRIPTION OF THE PREFERRED EMBODIMENTS

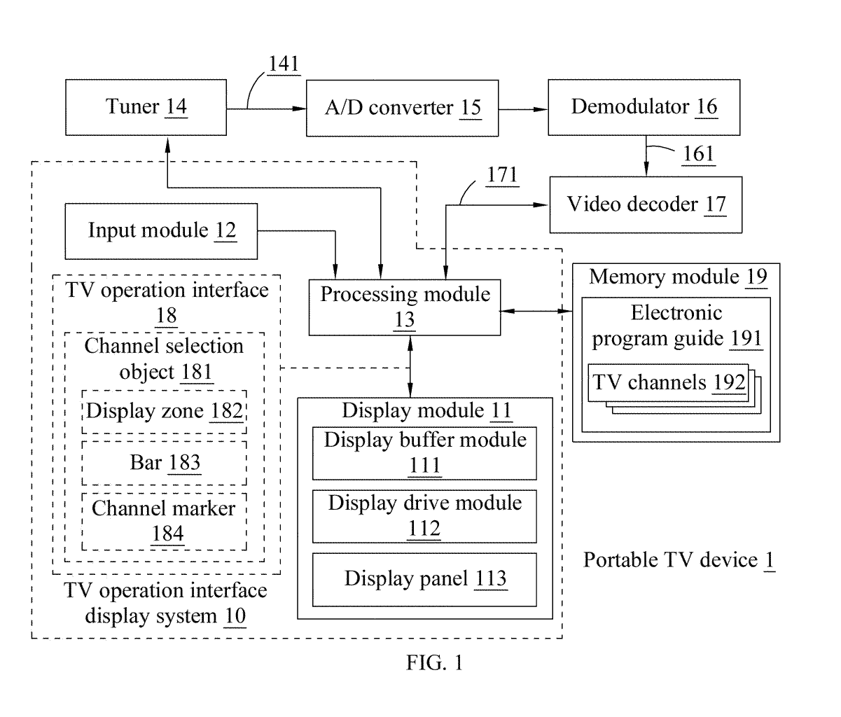

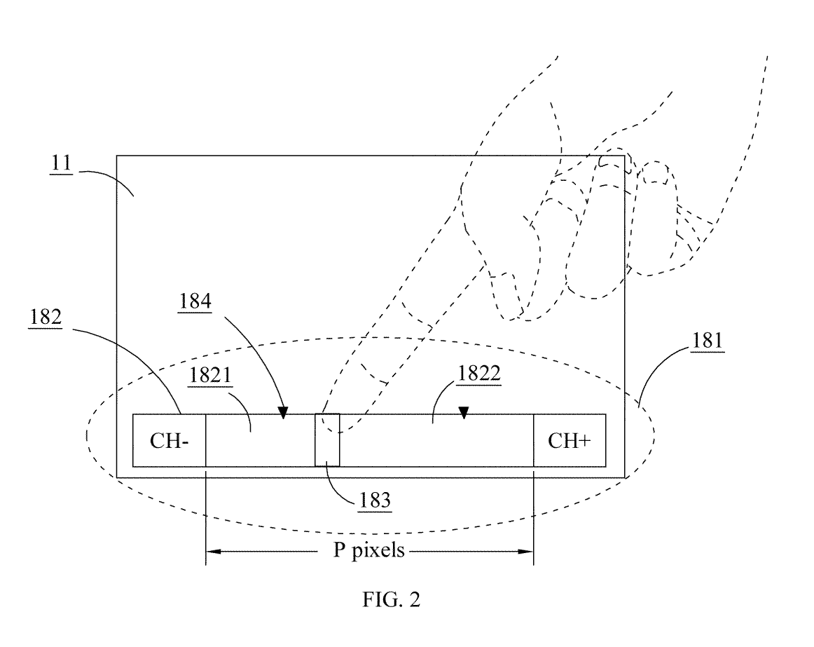

Please refer to FIG. 1 which is an exemplary block diagram of a television (TV) operation interface display system 10 according to the present invention, and to FIG. 2 which is an exemplary view of a TV operation interface 18 according to the present invention. The illustrated TV operation interface display system 10 is applicable to a portable TV device 1, and includes a display module 11, an input module 12, and a processing module 13. The portable TV device 1 further includes a tuner 14, an analog-to-digital (A/D) converter 15, a demodulator 16, a video decoder 17, and a memory module 19. The tuner 14 receives a wireless TV signal 141, which is then converted by the A/D converter 15 into a digital signal. The demodulator 16 demodulates the digital signal to an encoded video signal 161, which is further decoded by the video decoder 17 into a TV program signal 171. The display module 11 includes a display buffer module 111, a display drive module 112, and a display panel 113. The processing module 13 controls and transmits the TV program signal 171 to the display buffer module 111 for storing therein. The display drive module 112 periodically drives the display panel 113 to show data stored in the display buffer module 111. When the portable TV device 1 is started for the first time, the processing module 13 controls the tuner 14 to scan all TV channels, and records the channel data scanned by the tuner 14 to provide an electronic program guide (EPG), which is stored in the memory module 19. Via the input module 12, a user can operate the TV operation interface display system 10. The input module 12 is implemented as a touch module by which a position on the display panel 113 that has been touched by the user is output. Alternatively, the input module 12 may also be implemented as a cursor-control module by which a position of the cursor is output.

The processing module 13 controls the display module 11 to display a TV operation interface 18. The TV operation interface 18 includes a channel selection object 181, which has a display zone 182 corresponding to a plurality of TV channels 192 recorded in the electronic program guide 191. The TV operation interface 18 may be designed to automatically minimize to the edge of an screen or simply disappear while the user is watching a TV program in a full screen mode, and may show up again while the user clicks the edge of an screen. Preferably, selection positions for these TV channels 192 are evenly distributed within in the display zone 182 of the channel selection object 181. The channel selection object 181 has an indicating object, which is a bar 183 in the illustrated embodiment. The input module 12 may be arranged for accepting the user's input to manipulate the bar 183 for selecting one of the TV channels 192. The processing module 13 determines whether the bar 183 has been moved according to a touch position data generated by the input module 12. If it is determined by the processing module 13 that the bar 183 has been touched and the touch position is moved, the processing module 13 can determine that the bar 183 has been moved. As shown in FIG. 2, when there are N TV channels 192 and the display zone 182 has a width of P pixels, each of the TV channels 192 would occupy a selection zone having P/N pixels. That is, when the bar 183 is moved to a selection zone between 0 and the P/N^{th} pixel, the processing module 13 controls the tuner 14 to switch to the first TV channel 192; when the bar 183 is moved to a selection zone between the P/N^{th} pixel and the 2×P/N^{th} pixel, the processing module 13 controls the tuner 14 to switch to the second TV channel 192; and when the bar 183 is moved to a selection zone between the 2×P/N^{th} pixel and the 3×P/N^{th} pixel, the processing module 13 controls the tuner 14 to switch to the third TV channel 192. Similarly, when the bar 183 is moved to a selection zone between the (n−1)×P/N^{th} pixel and the n×P/N^{th} pixel, the processing module 13 controls the tuner 14 to switch to the N^{th} TV channel 192.

Since every TV channel 192 has an absolute selection position on the TV operation interface 18, a user can more efficiently and more quickly select a desired TV channel. Further, in the case that some specific TV channels are pre-set by the user, such as his or her favorite channels, a channel marker 184 can be shown on the channel selection object 181 corresponding to each of the preset TV channels. The channel marker 184 is shown on the channel selection object 181 at the selection zone corresponding to the preset TV channel, allowing the user to easily recognize the preset TV channel. When the bar 183 is moved to near the channel marker 184, the bar 183 will automatically align with the channel marker 184, and the processing module 13 will switch to the TV channel 192 corresponding to the channel marker 184. In this way, the user can more easily select the preset TV channel. For example, when the fourth TV channel 192 has been preset as the user's favorite channel, it is possible to set a range between the 1×P/N^{th} pixel and the 5×P/N^{th} pixel as a selection sensing range for the fourth TV channel 192. Thus, whenever the bar 183 is moved into the above sensing range, the processing module 13 will switch to the fourth TV channel 192.

The TV operation interface 18 also allows the user to set his or her favorite channel(s). The bar 183 may be continuously touched at a fixed position in the display zone 182 for a preset time period. By doing so, the processing module 13 is triggered to set the TV channel 192 corresponding to the fixed position as a favorite channel and stores it in the memory module 19, and a channel marker 184 will be shown on this fixed position.

The display zone 182 is divided by the bar 183 into two zones, namely, a first zone 1821 and a second zone 1822. If the user's input accepted by input module 12 indicates a manipulated position in either the first zone 1821 or the second zone 1822 such input may trigger the processing module 13 to switch the TV channels. For instance, when the processing module 13 determines that the touch position generated by the input module 12 is within the first zone 1821, the tuner 14 is controlled to lock to a preceding TV channel in the electronic program guide 191. Or, when the touch position is within the second zone 1822, the tuner 14 is controlled to lock to a following TV channel. Further, each time the first zone 1821 or the second zone 1822 is touched to trigger the processing module 13, the processing module 13 will show the bar 183 at a channel position corresponding to a TV channel 192 being switched to. Thus, when the user touches the first zone 1821 or the second zone 1822 to operate the TV operation interface 18, the displayed zone of the first or the second zone 1821, 1822 is changed with the touch. In conclusion, the user can first move the bar 183 to enable switching of TV channels within a large span of the display zone 182, and then touches the first zone 1821 or the second zone 1822 to enable fine switching of TV channels.

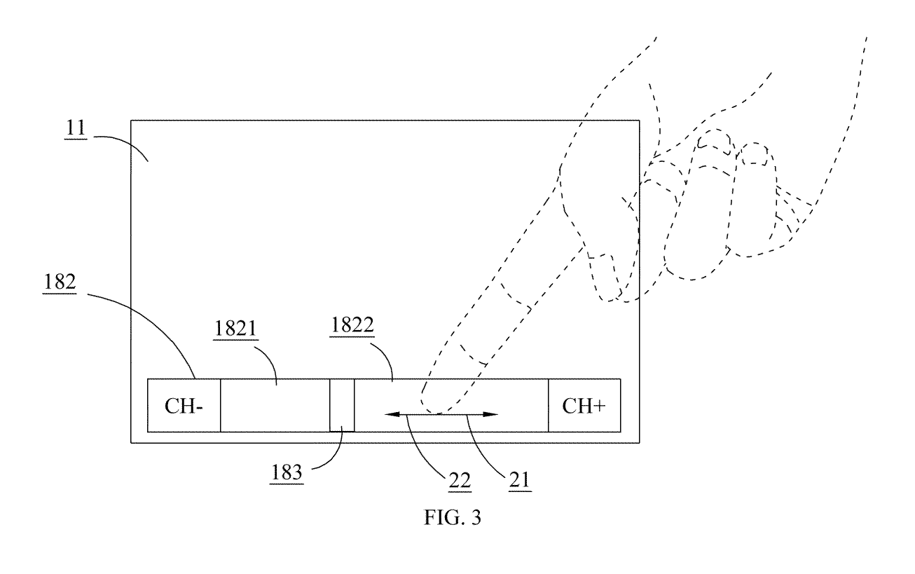

Further, the processing module 13 can control the speed of switching TV channels according to duration for which the user's input exists at the manipulated position in the first or the second zone 1821, 1822. For instance, when the touch duration is within 2 seconds, the processing module 13 switches one single TV channel each time; when the touch duration is longer than 2 second but shorter than 4 seconds, the processing module 13 switches two TV channels at a time; or when the touch duration is longer than 4 seconds, the processing module 13 switches four TV channels at a time. In this way, the TV operation interface 18 provides the user an alternative for switching the TV channels quickly. Further, when the user touches the first or the second zone 1821, 1822 while sliding, the processing module 13 will switch the TV channels according to a sliding distance. As shown in FIG. 3, when the user touches the second zone 1822 while sliding, the processing module 13 will switch to a following channel no matter the user slides in which direction along the second zone 1822. Similarly, when the user touches the first zone 1821 while sliding, the processing module 13 will switch to a preceding channel no matter the user slides in which direction along the first zone 1821. At this point, the processing module 13 will determine the TV channel switching speed according to the sliding distance 21 or 22. To achieve the effect of fine switching, the channel switching can be increased to, for example, 3×P/N pixels. That is, when the sliding distance 21 or 22 is larger than 3P/N pixels, the processing module 13 controls the tuner 14 to switch to a following TV channel.

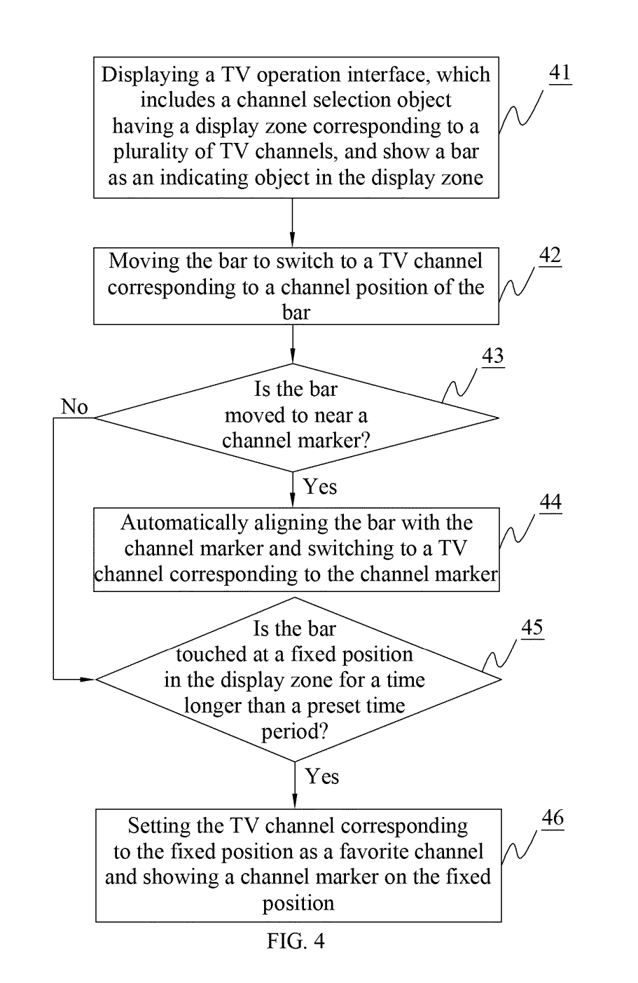

Please refer to FIG. 4 which is a flowchart showing the steps included in an operation method for switching TV channels according to the present invention. As shown, the operation method for switching TV channels includes the following steps:

Step 41: A TV operation interface is displayed. The TV operation interface includes a channel selection object, which has a display zone corresponding to a plurality of TV channels and has a bar as an indicating object shown in the display zone, as shown in FIG. 2.

Step 42: The bar is moved to switch to a TV channel corresponding to a channel position of the bar.

Step 43: Whether the bar is moved to near a channel marker is determined. If yes, go to Step 44; or if not, go the Step 45.

Step 44: The bar is automatically aligned with the channel marker, and a TV channel is switched to corresponding to the channel marker.

Step 45: It is determined whether the bar is touched at a fixed position in the display zone for a time longer than a preset time period. If yes, go to Step 46.

Step 46: The TV channel corresponding to the fixed position is set as a favorite channel and show a channel marker on the fixed position.

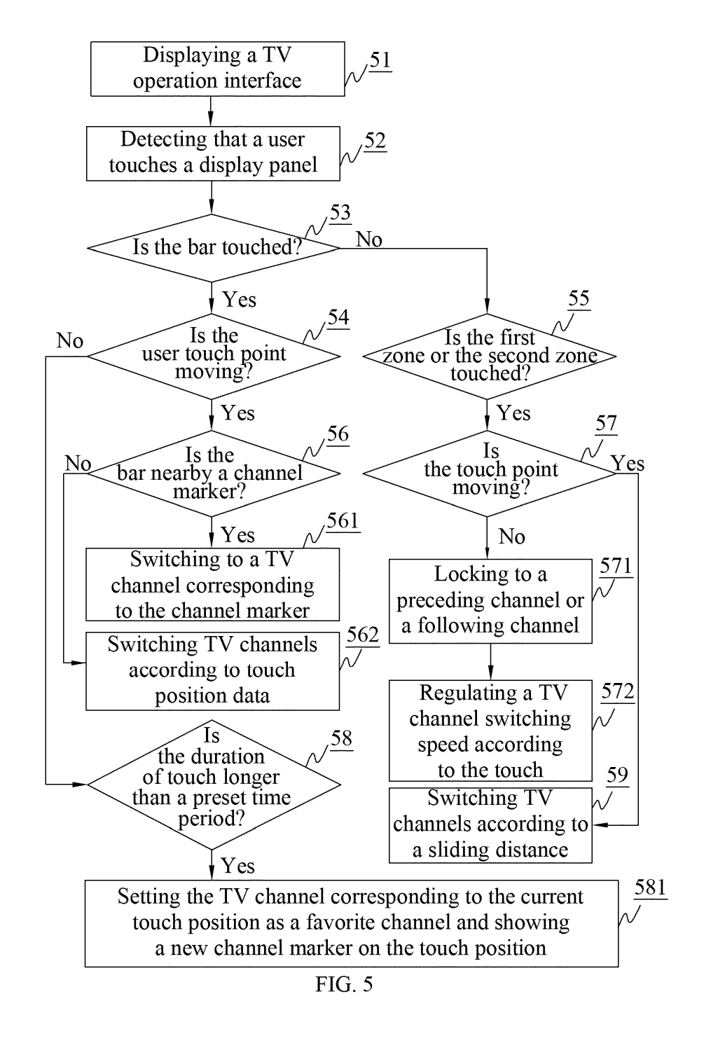

FIG. 5 is a flowchart showing the operation method for switching TV channels according to an embodiment of the present invention. As shown, the operation method in the illustrated embodiment is applicable to the TV operation interface display system 10, and includes the following steps:

Step 51: The display module 11 is controlled by the processing module 13 to show a TV operation interface, which includes a channel selection object 181 having a bar 183 as an indicating object and at least one channel marker 184, and the channel selection object 181 has a display zone 182 corresponding to a plurality of TV channels 192. Since the corresponding relation has been described above, it is not repeatedly discussed herein.

Step 52: By the input module 12, it is detected that the display panel 113 is touched by a user, and a touch position data is output.

Step 53: It is determined by the processing module 13 according to the touch position data that whether the user touches the bar 183. If yes, go to Step 54; or if not, go to Step 55.

Step 54: By the processing module 13, it is determined whether the user touch point is moving according to the touch position data. If yes, go to Step 56 to determine whether the current touch position is located nearby the channel marker 184. If yes, go to Step 561 to switch to a TV channel 192 that corresponds to the channel marker 184; or if not, go to Step 562 to control the tuner 14 to switch TV channels according to the touch position data. On the other hand, if it is determined in Step 54 that the user touch point is not moving, go to Step 58 to determine whether the user touch point has been continuously touched for a time longer than a preset time period. If yes, go to Step 581 to set the TV channel corresponding to the current touch position as a favorite channel and show a new channel marker 184 on the touch position.

Step 55: It is determined according to the touch position data whether the user touches the first zone 1821 or the second zone 1822. If yes, go to Step 57 to determine according to the touch position data whether the user touch point is moving. If not, go to Step 571 to control the tuner 14 to lock to a preceding channel or a following channel, and then go to Step 572 to regulate a TV channel switching speed according to the touch.

On the other hand, if it is determined in Step 57 that the user touch point is moving, go to Step 59 to switch TV channels according to a sliding distance.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A TV operation interface display system for a user to switch TV channels, comprising:
a display module;
a processing module arranged for controlling the display module to show a TV operation interface; the TV operation interface including a channel selection object, and the channel selection object having a display zone corresponding to a plurality of TV channels, an indicating object, and a channel marker; the processing module showing the indicating object at a channel position corresponding to the TV channel being switched to; and
an input module arranged for accepting the user's input to manipulate the indicating object, thereby selecting one of the TV channels;
wherein when the indicating object is moved to near the channel marker, the indicating object automatically aligns with the channel marker and the processing module switches to the TV channel corresponding to the channel marker.

2. The TV operation interface display system as claimed in claim 1, wherein the channel marker marks a selection position for a favorite channel, in which when the indicating object is touched at a fixed position in the display zone for a time longer than a preset time period, the processing module sets the TV channel corresponding to the fixed position as the favorite channel and shows the channel marker on the fixed position.

3. The TV operation interface display system as claimed in claim 1, wherein the display zone is divided by the indicating object into a first zone and a second zone, and the processing module is triggered to switch TV channels when the user's input accepted by the input module indicates a manipulated position in either the first zone or the second zone.

4. The TV operation interface display system as claimed in claim 3, wherein the processing module switches TV channels by finely switching the TV channels.

5. The TV operation interface display system as claimed in claim 3, wherein the processing module controls a TV channel switching speed according to duration for which the user's input exists at the manipulated position in the first zone or the second zone.

6. The TV operation interface display system as claimed in claim 3, wherein the processing module switches TV channels according to a sliding distance when the user touches the first zone or the second zone while sliding.

7. The TV operation interface display system as claimed in claim 1, wherein selection positions for the plurality of TV channels are evenly distributed within in the display zone of the channel selection object.

8. A TV operation interface display system for a user to switch TV channels, comprising:
a display module;
a processing module arranged for controlling the display module to show a TV operation interface; the TV operation interface including a channel selection object, and the channel selection object having a display zone corresponding to a plurality of TV channels and having an indicating object; the processing module showing the indicating object at a channel position corresponding to the TV channel being switched to; and
an input module arranged for accepting the user's input to manipulate the indicating object, so as to control the processing module to switch to the TV channel corresponding to the channel position of the indicating object;
wherein when the indicating object is touched at a fixed-position in the display zone for a time longer than a preset time period, the processing module sets the TV channel corresponding to the fixed position as a favorite channel and shows a channel marker on the fixed position.

9. The TV operation interface display system as claimed in claim 8, wherein when the indicating object is moved to near the channel marker, the indicating object automatically aligns with the channel marker and the processing module switches to the favorite channel corresponding to the channel marker.

10. The TV operation interface display system as claimed in claim 8, wherein the display zone of the channel selection object is divided by the indicating object into a first zone and a second zone, and the processing module is triggered to switch TV channels when the user's input accepted by the input module indicates a manipulated position in either the first zone or the second zone.

11. The TV operation interface display system as claimed in claim 10, wherein the processing module controls a TV channel switching speed according to duration for which the user's input exists at the manipulated position in the first zone or the second zone.

12. The TV operation interface display system as claimed in claim 10, wherein the processing module switches TV channels according to a sliding distance when the user touches the first zone or the second zone while sliding.

13. The TV operation interface display system as claimed in claim 8, wherein selection positions for the plurality of TV channels are evenly distributed within in the display zone of the channel selection object.

14. An operation method for switching TV channels, comprising the steps of:
displaying a TV operation interface; the TV operation interface including a channel selection object comprising a display zone corresponding to a plurality of TV channels;
showing in the display zone an indicating object and a channel marker, the indicating object being at a channel position corresponding to one of the plurality of TV channels being switched to;
moving the indicating object to select another one of the plurality of TV channels; and
automatically aligning the indicating object with the channel marker when the indicating object is moved to near the channel marker, and switching to the TV channel corresponding to the channel marker.

15. The operation method for switching TV channels as claimed in claim 14, wherein the channel marker marks a selection position for a favorite channel, in which when the indicating object is touched at a fixed position in the display zone for a time longer than a preset time period, the processing module sets the TV channel corresponding to the fixed position as the favorite channel and shows the channel marker on the fixed position.

16. The operation method for switching TV channels as claimed in claim 14, wherein the display zone is divided by the indicating object into a first zone and a second zone, and the operation method further comprising the step of touching and triggering either the first zone or the second zone to enable switching of the plurality of TV channels.

17. The operation method for switching TV channels as claimed in claim 14, further comprising the step of switching TV channels by finely switching the TV channels when the first zone or the second zone is touched and triggered.

18. The operation method for switching TV channels as claimed in claim 17, further comprising the step of controlling a TV channel switching speed according to duration for which the user touches to trigger the first zone or the second zone.

19. The operation method for switching TV channels as claimed in claim 17, further comprising the step of switching the TV channels according to a sliding distance when the first zone or the second zone is touched and triggered while a touch point slides.

20. The operation method for switching TV channels as claimed in claim 14, wherein selection positions for the plurality of TV channels are evenly distributed within in the display zone of the channel selection object.

21. An operation method for switching TV channels, comprising the steps of:
displaying a TV operation interface; the TV operation interface including a channel selection object comprising a display zone corresponding to a plurality of TV channels;
showing in the display zone an indicating object, the indicating object being at a channel position corresponding to one of the plurality of TV channels being switched to;
moving the indicating object to switch to another one of the plurality of TV channels at the channel position corresponding to the indicating object; and
setting the TV channel corresponding to a fixed position as a favorite channel and showing a channel marker on the fixed position when the indicating object is touched at the fixed position in the display zone for a time longer than a preset time period.

22. The operation method for switching TV channels as claimed in claim 21, further comprising the step of automatically aligning the indicating object with the channel marker when the indicating object is moved to near the channel marker, and switching to the favorite TV channel corresponding to the channel marker.

23. The operation method for switching TV channels as claimed in claim 21, wherein the display zone of the channel selection object is divided by the indicating object into a first zone and a second zone, and the operation method further comprising the step of touching and triggering either the first zone or the second zone to enable switching of the plurality of TV channels.

24. The operation method for switching TV channels as claimed in claim 23, further comprising the step of controlling a TV channel switching speed according to duration for which the user touches to trigger the first zone or the second zone.

25. The operation method for switching TV channels as claimed in claim 23, further comprising the step of switching the TV channels according to a sliding distance when the first zone or the second zone is touched and triggered while a touch point slides.

26. The operation method for switching TV channels as claimed in claim 21, wherein selection positions for the plurality of TV channels are evenly distributed within in the display zone of the channel selection object.
